(19) United States
(12) Patent Application Publication
(10) Pub. No.: US 2008/0248845 A1
(43) Pub. Date: Oct. 9, 2008

(54) Contextual Gamer Options Menu

(76) Inventors: Henry Paul Morgan, Redmond, WA (US); David Raymond Shaw, North Bend, WA (US); Jerry Alan Johnson, Medina, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(21) Appl. No.: 11/697,495

(22) Filed: Apr. 6, 2007

(51) Int. Cl. A63F 13/00

(52) U.S. Cl. 463/1

(57) ABSTRACT

A dynamically configurable contextual gamer options menu provides options to online game players. The game options are determined as a function of the game being played and relationships between game players. Game options are updated, added, and/or deleted dynamically as relationships and context change.

### TECHNICAL FIELD

The technical field relates generally to computer processing and more specifically to online game playing.

### BACKGROUND

Online gaming is a vastly expanding enterprise, with ever more sophisticated players who demand increased capabilities and flexibilities from gaming systems. A problem with current games and gaming systems is that menus are static. Current menus statically limit players to predetermined menu selections, and do not take into account the contexts in which players are playing games. Typically, the interaction between a game service's user interface and a game console's user interface is limited. Specialized actions that a game service wishes to provide for a particular player must be displayed within the game console's user interface, requiring additional work on the part of the game developer and potentially degrading the overall game playing experience.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

A dynamically configurable contextual gamer options menu provides options to game players as a function of the game being played and the relationships between game players. The number of options and the types of options in the menu are dynamically changeable in accordance with changes in the game being played and changes in the relationships between game players.

### BRIEF DESCRIPTION OF THE DRAWINGS

The foregoing summary, as well as the following detailed description, is better understood when read in conjunction with the appended drawings. For the purpose of illustrating a contextual gamer options menu, there is shown in the drawings exemplary constructions thereof; however, a contextual gamer options menu is not limited to the specific methods and instrumentalities disclosed.

FIG. 1 is an example system diagram illustrating an implementation of a dynamic contextual gamer options menu.

FIG. 2 is an illustration of an example dynamic contextual gamer options menu

FIG. 3 is another illustration of an example dynamic contextual gamer options menu.

FIG. 4 is another illustration of an example dynamic contextual gamer options menu depicting dynamic actions.

FIG. 5 is an illustration of an example dynamic contextual gamer options menu depicting a game option allowing a game player access to another game player's game specific information.

FIG. 6 is an illustration of an example dynamic contextual gamer options menu depicting a game option allowing a game player to send custom messages to another game player.

FIG. 7 is a flow diagram of an example process for rendering game options via a dynamic contextual gamer options menu.

FIG. 8 is a block diagram of an example game console in which a dynamic contextual gamer options menu can be implemented.

FIG. 9 is a diagram of an exemplary processor for implementing a dynamic contextual gamer options menu.

FIG. 10 is a depiction of an example suitable computing environment in which a dynamic contextual gamer options menu can be implemented.

### DETAILED DESCRIPTION OF ILLUSTRATIVE EMBODIMENTS

A dynamically configurable contextual gamer options menu provides options to game players as a function of the game being played and the contextual relationships between game players. Various buttons on the menu are generated and/or changed as a function of the type of relationship between players and the state of the players. A first player can look at a gamer profile of a second player, and in the context of a specific game, the options in the dynamically configurable contextual gamer options menu are generated based on information associated with the first player and the second player. For example, if the first player is member of a team in a game (e.g., HALO 2), the first player can invite the second player to join the first player's team. The invitation option is rendered via the dynamically configurable contextual gamer options menu. The dynamically configurable contextual gamer options menu is rendered on the second player's game device (e.g., dedicated game console such as XBOX® 360, a general purpose processor such as a PC). In an example embodiment utilizing XBOX® 360 as a game device, the dynamically configurable contextual gamer options menu is rendered as part of a player's gamercard.

Game options are added, deleted, and/or modified to the dynamic contextual gamer options menu by a game application. The game application receives information, from a game service/system, indicating that a first player is being provided information about a second player. The game can specify additional custom actions, determined by, and relevant to the game. The game is notified, by the game service/system; that a custom action was taken by the first player with respect to the second player. In an example embodiment, game options are enabled by the first player running the game, being connected to the game service/system, and taking action to view the second player. However, it is not required that the second player be in a particular state on the game service/system, other than the second player is known to the game service/system. The second player can be online or offline.

Game options can be added, deleted, and/or modified to the dynamic contextual gamer options menu on a per-user basis. In an example embodiment, if a first player looks at a second player's profile, the game can modify the types of actions that are available to the first player on the second player's profile based on the context of the relationship between the first and second players. For example, if the second player is not a friend of the first player (e.g., is not on the first player's friends list), a game option, such as “Add Friend,” is dynamically rendered in the dynamic contextual gamer options menu of the first player, allowing the first player to invite the second player to join the first player's friends list. As another example, if the second player is not in the first player's guild or team, a game option, such as “Invite to Guild” or “Invite to Team” is dynamically rendered in the dynamic contextual gamer options menu of the first player, allowing the first player to invite the second player to join the first player's guild or team. As another example in which two players are on the same team, wherein player 1 is a team captain and player 2 is on his team, the options can comprise “Promote To Co-Captain” and “Remove From Team”.

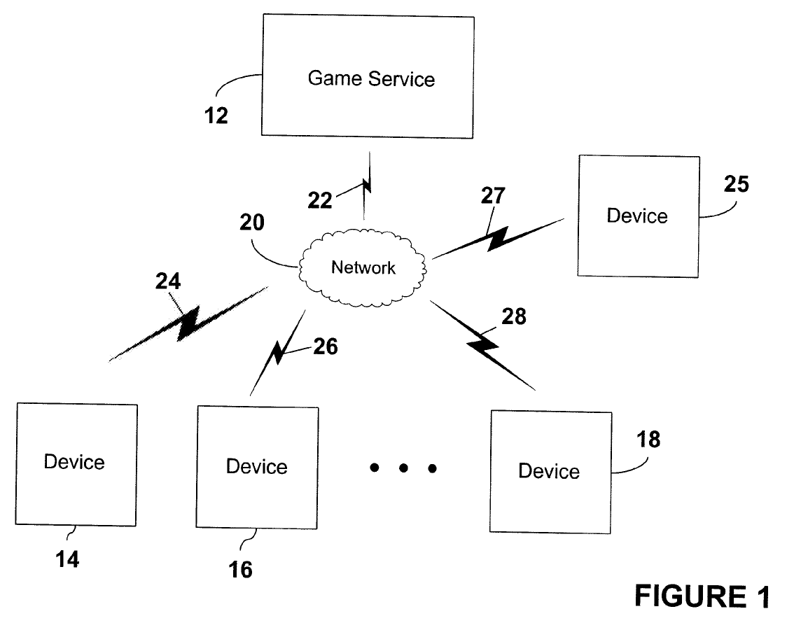

FIG. 1 is an illustration of an example system in which a dynamic contextual gamer options menu can be utilized. The game service 12 provides gaming services to the devices 14, 16, 18, via a network 20. The game service 12 can be part of a service, such as an online game service, for example. The game service 12 can comprise any appropriate processor or combination of processors configured to provide gaming services to the devices 14, 16, 18. In an example configuration the game service 12 comprises a server or servers configured to provide services in connection with an online, multiplayer gaming such as, for example, XBOX® LIVE™, which is provided by MICROSOFT CORPORATION of Redmond, Wash. The network 20 can comprise any appropriate network, such as a local area network (LAN), a wide area network, the internet, a home network, and enterprise network, or a combination thereof, for example.

The devices 14, 16, and 18, represent any appropriate device or devices configured to render a dynamic contextual gamer options menu. In an example embodiment, as described herein, rendering a game option comprises a displayable indication of a game option. The devices 14, 16, and 18 can represent a single device. The devices 14, 16, and 18 can represent multiple devices. Each device 14, 16, and 18, can comprise any appropriate processor capable of rendering a dynamic contextual gamer options menu, such as a general purpose processor, a laptop, a PC, a desktop, a server, a set-top box, a portable phone, a portable entertainment device, a personal digital assistant (PDA), a dedicated game console (e.g., XBOX® 360), or the like. The game service 12 and the devices 14, 16, and 18, are coupled to the network 20, via interfaces 22, 24, 26, 27, and 28, respectively. The interfaces 22, 24, 26, 27, and 28, are representative of any appropriate interface, such as a wireless interface, a wired interface, or a combination thereof. The devices 14, 16, 18, can communicate therebetween via the network 20. The devices 14, 16, 18, can communicate therebetween via the network 20 and the game service 12.

The processor 25 represents any appropriate processor configured to provide information to the devices 14, 16, 18, pertaining to information (e.g., relationships, actions) about game players and games. For example, the processor 25 can comprise a general purpose processor, an XBOX® Live Server Platform (XLSP), a portion of devices 14, 16, 18 (e.g., the processor 25 can be part of a game console), or a combination thereof. In an example embodiment, the devices 14, 16, 18 can be connected to the game service 12, and the dynamic game options menu accesses the processor 25 to obtain information stored outside the game service 12, in order to determine relationships and therefore the list of options to be rendered. In an example embodiment, the game service 12 provides game options to the game devices 14 16, 18. For example, two-way communication can be established between the game device 14, 16, 18, and the game service 12. The game device 14, 16, 18, provides the game service 12 with context (e.g., this is Player 1 inquiring about Player 2) and the game service 12 provides to the game devices 14, 16, 18, a set of game options that can be performed on behalf of the relationship between Player 1 and Player 2.

In an example scenario, wherein the devices 14, 16, 18, comprise XBOX® 360 game consoles and the game service 12 comprises an XBOX® LIVE service, a first player can be playing an online line multiplayer game, X, on a first XBOX® 360 game console, and a second player can be playing the same online multiplayer game, X, on a second XBOX® 360 game console. The game, X, receives notification of which player is viewing and which is being viewed, and the game contacts any appropriate processor (e.g., the processor 25, an XLSP server, or the like) to request information about relationships between players and games. The processor returns relationship information, and the game calls an API (application program interface) to render the appropriate game options (set the appropriate buttons) in the dynamic contextual gamer options menu. The first player can select a game option from the dynamic contextual gamer options menu. Upon receiving a notification (from the user interface, UI, and/or the operating system of the game console) of the game option selected by the first player, the game application determines the appropriate action to take based upon the first player's selected game option. The game application then takes the appropriate action.

In an example embodiment, the devices 14, 16, 18, can comprise a game console or a general purpose processor, such as a personal computer (PC), or the like, wherein the game console/PC comprises system software different than a game application. In this example embodiment, the system software detects user interface (UI) events (e.g., display information related to other players) occurring on the game console/PC. The system software provides notifications to the game application of the UI events. The game application receives the notifications and obtains relationship information related to the UI event. The game application can obtain relationship information pertaining to a UI event about another game player from any appropriate source such as the game service 12, the processor 25, the game device 14, 16, 18, or a combination thereof, for example. The game application, upon receiving the relationship information, determines if a game option is to be specified in the dynamic contextual gamer options menu pertaining to the relationship information. If the game application determines that a game option is to be specified in the dynamic contextual gamer options menu, the game option is displayed in the dynamic contextual gamer options menu.

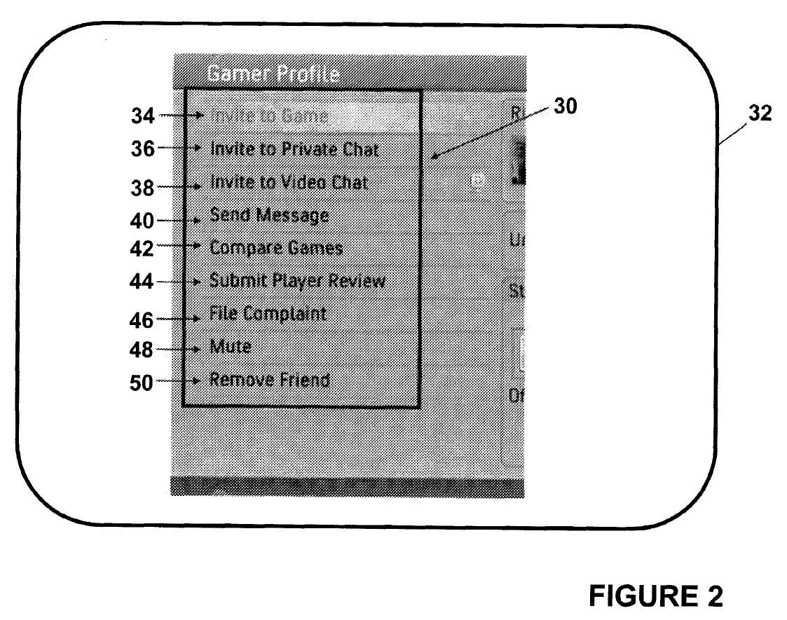

FIG. 2 is an illustration of an example dynamic contextual gamer options menu 30. FIG. 1 depicts an example “screen shot” of the menu 30 comprising game system options. As described below, dynamically generated contextual game options can be added to the list of game options depicted in FIG. 2. The dynamic contextual gamer options menu 30 is depicted as being rendered on display 32. The display 32 can comprise any appropriate display, such a display on a device 14, 16, 18. The dynamic contextual gamer options menu 30 can be rendered at any appropriate location on the display 32. The dynamic contextual gamer options menu 30 comprises a variety of game options: “Invite to Game” 34, “Invite to Private Chat” 36, “Invite to Video Chat” 38, “Send Message” 40, Compare Games” 42, “Submit Player Review” 44, “File Complaint” 46, “Mute” 48, and “Remove Friend” 50. Any appropriate number of options and option types can be rendered. The options rendered in the menu 30 are contextual in the sense that the options rendered are dependent upon the type of game being played and the relationship between players. The dynamic contextual gamer option menu 30 is a menu of gamer options that tell a first player what options are available pertaining to a second player being viewed. The menu 30 is contextual in the sense that the system options can be made available in accordance with the context as seen by the game. The menu 30 is dynamic in the sense that the game comprises the ability to populate the menu 30 with game options in accordance with a current player relationship/game context.

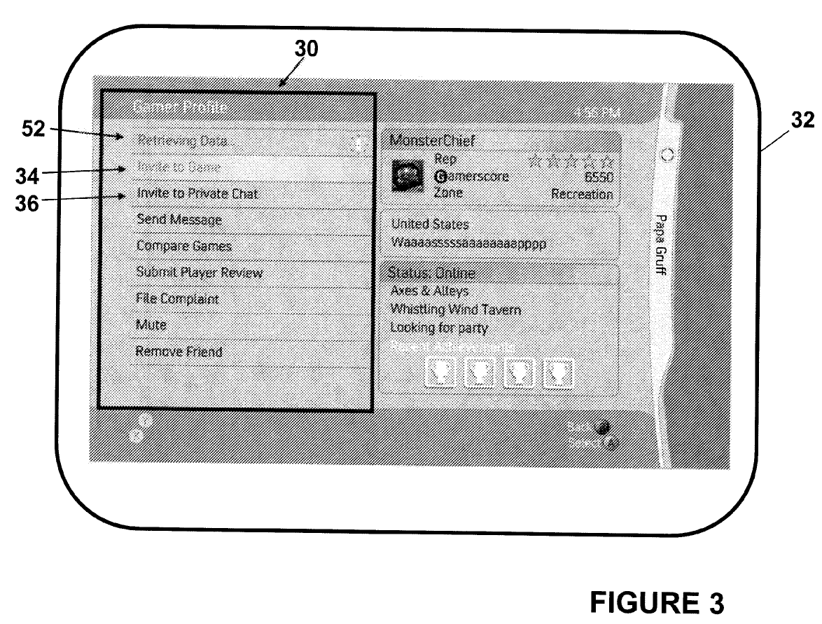

FIG. 3 is another illustration of an example dynamic contextual gamer options menu 30. Game option 52 rendered as “Retrieving Data” 52 provides an indication that action is being undertaken. The “Retrieving Data” option 52 is rendered until the game adds its options or until a timeout is reached. This indicates to the player that there is something else possibly coming into the list of game options. The “Retrieving Data” option 52 is rendered as a placeholder until the game options of the menu 30 are set. Once the game options are set (e.g., a “set buttons” API is called), the “Retrieving Data” option 52 is removed and the new list of game options is rendered along with the game system provided game options. Game options in the dynamic contextual gamer options menu 30 are dynamically rendered. That is, a game option in the dynamic contextual gamer options menu 30 can be rendered when the game context and/or the relationship between players warrants rendering, and the game option will not be rendered when the game context and/or the relationship between players does not warrant rendering.

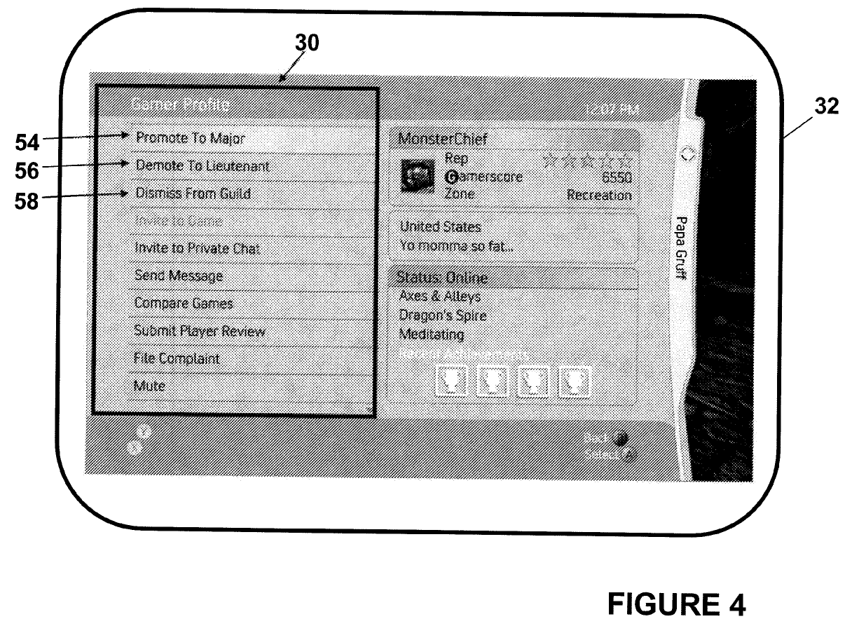

FIG. 4 is an illustration of an example dynamic contextual gamer options menu 30 depicting dynamic actions. As depicted in FIG. 4, a first player, “Papa Gruff,” has a choice of game options that are dependent upon PapaGruff's relationship with a second player, “MonsterChief,” and Monster Chief's relationship with the game, “Axes & Alleys.” For example, Papa Gruff can promote MonsterChief to Major via game option 54, can demote MonsterChief to Lieutenant via game option 56, or dismiss MonsterChief from a guild via game option 58. If MonsterChief were already a Major or a Lieutenant, game options 55 and 56 would not be rendered in the dynamic contextual gamer options menu 30 on the display 32. If MonsterChief did not belong to the guild, game option 58 would not be rendered in the dynamic contextual gamer options menu 30 on the display 32. Instead, a game option such as “Invite to Guild” would be rendered in the dynamic contextual gamer options menu 30 on the display 32.

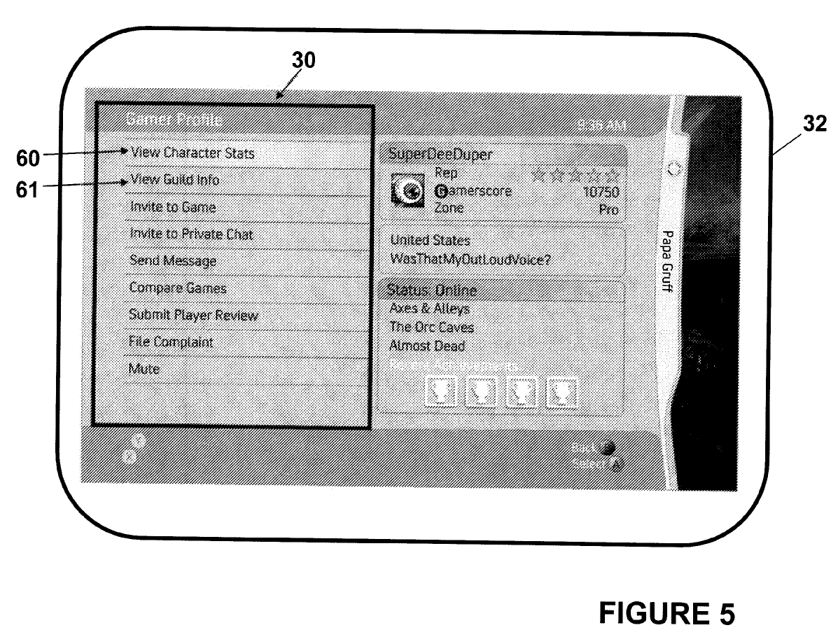

FIG. 5 is an illustration of an example dynamic contextual gamer options menu 30 depicting a game option 60 allowing a game player “Papa Guff,” access to another game player “SuperDeeDuper,” game specific information. Other game specific information can be accessed via game options in the dynamic contextual gamer options menu 30, such as guild information and character statistics. The game option 61 “View Guild Info” is another example of a dynamic game option. Selecting a dynamic game option, such as “View Character Stats” 60 or “View Guild Info” 61, results in the game taking actions based on the game option selected.

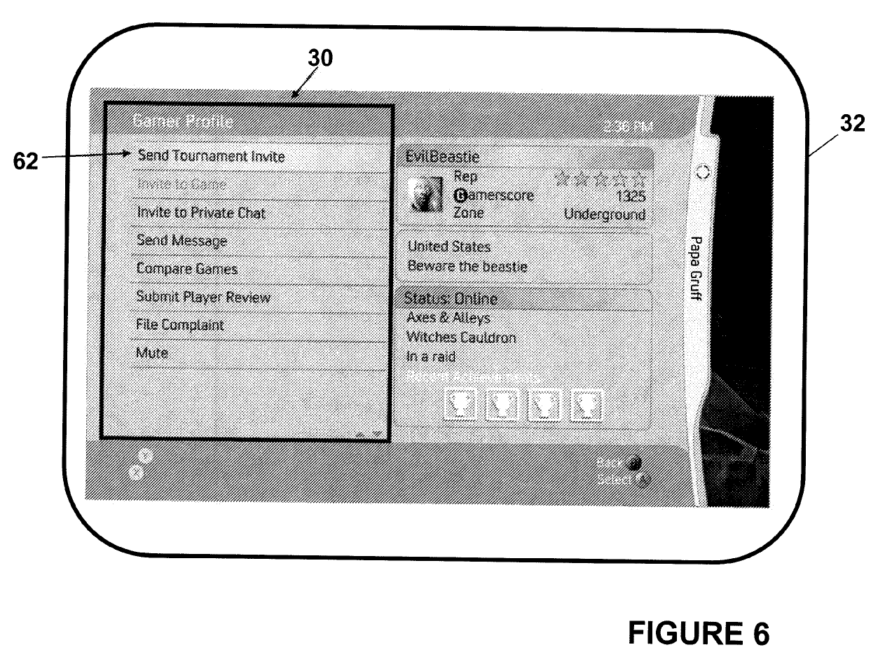

FIG. 6 is an illustration of an example dynamic contextual gamer options menu 30 depicting a game option 62 allowing a game player “Papa Guff,” to send an invitation to join a tournament to another game player's “EvilBeastie.” In an example embodiment, custom game options, such as game option 62 for example, are rendered at the top of the menu 30.

The number and types of game options that can be specified for the dynamic contextual gamer options menu is limitless. Some example game options include, but are not limited to, “Invite To Team,” “Remove From Team,” “Promote To Co-Captain,” “View Characters,” “View Best Times,” “Trail Of Destruction,” “View My Videos,” “View Face-In-Game,” and “Send A Clip.”

In an example embodiment, “Invite To Team” would appear when a team member is viewing a person who is not on her team. When the “Invite To Team” game option is selected, the profile UI closes, and the game would call an API to send a custom message outfitted as a team invite. “Invite To Team” is just one example of team management game options that are applicable to the dynamic contextual gamer options menu. “Remove From Team” and “Promote To Co-Captain” are examples of a game options that allows a player to manage a team.

“View Characters,” “View Best Times,” and “Trail Of Destruction,” are examples of game options that allow a player to view other players' information. “View Characters” is applicable to a Role-playing game wherein the player spends much time building up the character(s) that she plays and the statistics, abilities, and equipment of her character are part of the point of the game. When the “View Characters” game option is selected, the system UI closes and the game (as opposed to the game service) renders the character data appropriately. “View Best Times” is applicable to a racing game (e.g., NASCAR, dune buggy, motorcycle, speedboat, or the like) in which a player can track times on each individual course. When the “View Best Times” game option is selected, the system UI closes, and the game renders the track times in an appropriate way. “Trail of Destruction” is applicable to a first-person shooter game. The game tracks every player's progress over time and retains data about each player's ability with various weapons, on different maps, and each player's most impressive battle-related statistics. When the “Trail of Destruction” game option is selected, the system UI closes and the game renders statistics using graphs or the like on multiple navigable pages.

The “View My Videos” game option is applicable to a Karaoke or Dancing game wherein the game allows players to record and store videos of their performances. When the “View My Videos” game option is selected, the system UI closes, and the game obtains (e.g., from an XLSP server) the catalog of performances for the viewed player and the game renders the catalog allowing the player to make a selection therefrom. Upon selection from the catalog, the game retrieves renders the selected video.

The “View Face-In-Game” game option is applicable to a game that uses a camera (e.g., XBOX® camera technology) to photograph players' faces, allowing a player to have her face displayed in the game. In an example embodiment, a players also can store an images of their faces on an XLSP server or the like. When the “View Face-In-Game” game option is selected, the system UI closes, and the game switches to a view of respective player's heads rotating so each player can see other players' heads in the game.

In an example embodiment, the “Send A Clip” game option could be displayed opposite of “View My Videos” game option. Instead of the game showing a listing of all of the viewed player's videos, the game shows a list of all of the viewing player's videos and when the one to send is selected, the game calls an API to create a custom message outfitted as a clip recommendation. More generally, the game takes appropriate action to a chosen clip to the other player.

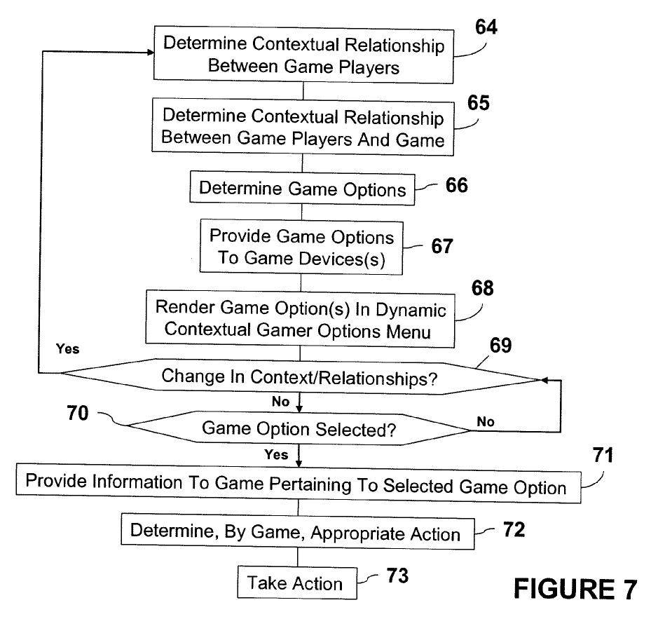

FIG. 7 is a flow diagram of an example process for rendering game options via a dynamic contextual gamer options menu. As described above, at step 64, contextual relationships between game players are determined. At step 65, contextual relationships between the players and the game are determined. Game options available to the viewing game player are specified at step 66. As described above, the game options are specified in accordance with the contextual relationships determined at steps 64 and 65. The game options are provided to the appropriate game player at step 67. As described above, respective game options are rendered via the dynamic contextual gamer options menu for the viewing game player at step 68. Context can be continuously monitored. Thus, if a relationship between players, or a relationship between a player and a game, changes the game options are appropriately changed. Accordingly, at step 69, it is determined if there is a change in context and/or a relationship. If a change occurs, the process proceeds to step 64 and continues as previously described to re-determine game options and render the re-determined game options via the dynamic contextual gamer options menu. Thus, game options are updated, added, and/or deleted dynamically as relationships and context change. If no change occurs (step 69), it is determined, at step 70, if a game option has been selected. If no game option is selected (step 70), the process proceeds to step 69. If a game option has been selected (step 70), the operating system or the like, of the processor executing the game application provides information to the game application pertaining to the selection of the game option. The game application, at step 72, determines the appropriate action to be taken, and the appropriate action is taken by the game application at step 73.

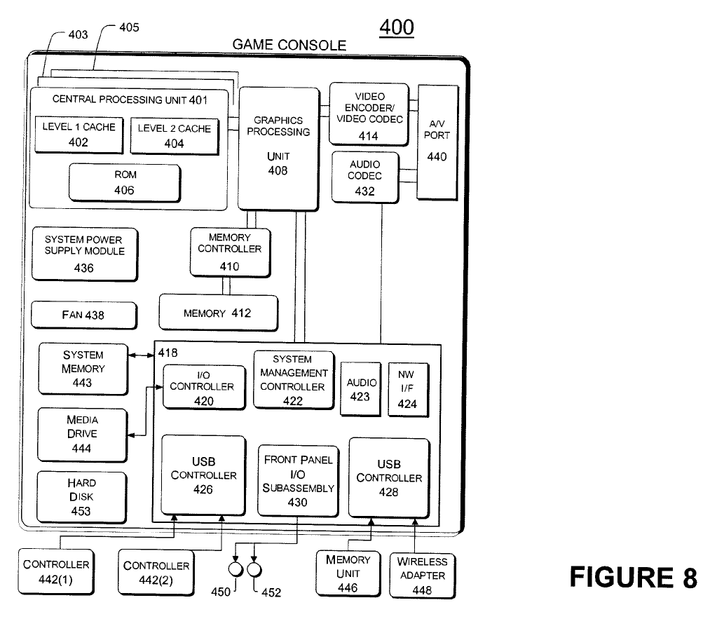

As described above, the game device (e.g., devices 14, 16, 18, in FIG. 1) can comprise a PC, a general purpose processor, a mobile device, a PDA, a dedicated game console or a combination thereof. FIG. 8 is a block diagram of an example game console 400 in which a dynamic contextual gamer options menu can be implemented. The game console 400 along with other devices described herein, such as a display device, are capable of performing the functions needed to determine and render a dynamic contextual gamer options menu, as describe above. Game console 400 is an example of a dedicated host system, although, as noted above, a game console is only one example of a dedicated host device. A typical game console comprises hardware and software that are specifically designed to support a core set of usage scenarios.

Game console 400 has a central processing unit (CPU) 401 having a level 1 (L1) cache 402, a level 2 (L2) cache 404, and a flash ROM (Read-only Memory) 406. The level 1 cache 402 and level 2 cache 404 temporarily store data and hence reduce the number of memory access cycles, thereby improving processing speed and throughput. The flash ROM 406 can store executable code that is loaded during an initial phase of a boot process when the game console 400 is initially powered. Alternatively, the executable code that is loaded during the initial boot phase can be stored in a FLASH memory device (not shown). Further, ROM 406 can be located separate from CPU 401. Game console 400 can, optionally, be a multi-processor system; for example game console 400 can have three processors 401, 403, and 405, where processors 403 and 405 have similar or identical components to processor 401.

A graphics processing unit (GPU) 408 and a video encoder/video codec (coder/decoder) 414 form a video processing pipeline for high speed and high resolution graphics processing. Data is carried from the graphics processing unit 408 to the video encoder/video codec 414 via a bus. The video processing pipeline outputs data to an A/V (audio/video) port 440 for transmission to a television or other display device. A memory controller 410 is connected to the GPU 408 and CPU 401 to facilitate processor access to various types of memory 412, such as, but not limited to, a RAM (Random Access Memory).

Game console 400 includes an I/O controller 420, a system management controller 422, an audio processing unit 423, a network interface controller 424, a first USB host controller 426, a second USB controller 428 and a front panel I/O subassembly 430 that may be implemented on a module 418. The USB controllers 426 and 428 serve as hosts for peripheral controllers 442(1)-842(2), a wireless adapter 448, and an external memory unit 446 (e.g., flash memory, external CD/DVD ROM drive, removable media, etc.). The network interface 424 and/or wireless adapter 448 provide access to a network (e.g., the Internet, home network, etc.) and may be any of a wide variety of various wired or wireless interface components including an Ethernet card, a modem, a Bluetooth module, a cable modem, and the like.

System memory 443 is provided to store application data that is loaded during the boot process. A media drive 444 is provided and may comprise a DVD/CD drive, hard drive, or other removable media drive, etc. The media drive 444 may be internal or external to the game console 400. When media drive 444 is a drive or reader for removable media (such as removable optical disks, or flash cartridges), then media drive 444 is an example of an interface onto which (or into which) media are mountable for reading. Application data may be accessed via the media drive 444 for execution, playback, etc. by game console 400. Media drive 444 is connected to the I/O controller 420 via a bus, such as a Serial ATA bus or other high speed connection (e.g., IEEE 4394). While media drive 444 may generally refer to various storage embodiments (e.g., hard disk, removable optical disk drive, etc.), game console 400 may specifically include a hard disk 452, which can be used to store game data, application data, or other types of data, and on which the file systems depicted in FIGS. 4 and 4 may be implemented.

The system management controller 422 provides a variety of service functions related to assuring availability of the game console 400. The audio processing unit 423 and an audio codec 432 form a corresponding audio processing pipeline with high fidelity, 4D, surround, and stereo audio processing according to aspects of the present subject matter described herein. Audio data is carried between the audio processing unit 423 and the audio codec 426 via a communication link. The audio processing pipeline outputs data to the A/V port 440 for reproduction by an external audio player or device having audio capabilities.

The front panel I/O subassembly 430 supports the functionality of the power button 450 and the eject button 452, as well as any LEDs (light emitting diodes) or other indicators exposed on the outer surface of the game console 400. A system power supply module 436 provides power to the components of the game console 400. A fan 438 cools the circuitry within the game console 400.

The CPU 401, GPU 408, memory controller 410, and various other components within the game console 400 are interconnected via one or more buses, including serial and parallel buses, a memory bus, a peripheral bus, and a processor or local bus using any of a variety of bus architectures.

When the game console 400 is powered on or rebooted, application data can be loaded from the system memory 443 into memory 412 and/or caches 402, 404 and executed on the CPU 401. The application can present a graphical user interface that provides a consistent user experience when navigating to different media types available on the game console 400. In operation, applications and/or other media contained within the media drive 444 may be launched or played from the media drive 444 to provide additional functionalities to the game console 400.

The game console 400 may be operated as a standalone system by simply connecting the system to a television or other display. In this standalone mode, the game console 400 may allow one or more users to interact with the system, watch movies, listen to music, and the like. However, with the integration of broadband connectivity made available through the network interface 424 or the wireless adapter 448, the game console 400 may further be operated as a participant in a larger network community.

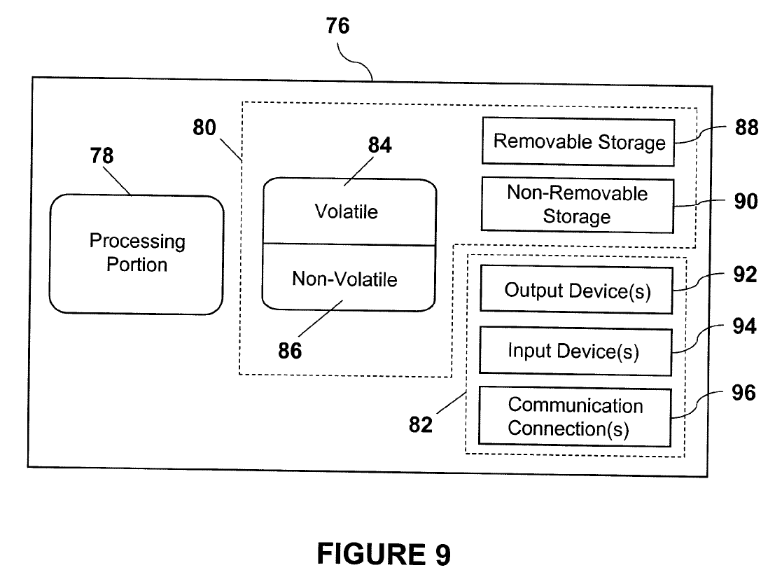

As described above, the game service (e.g., game service 12 in FIG. 1) can comprise a processor or combination of processors. FIG. 9 is a diagram of an exemplary processor 76 for generating and providing a dynamic contextual gamer options menu. The processor 76 comprises a processing portion 78, a memory portion 80, and an input/output portion 82. The processing portion 78, memory portion 80, and input/output portion 82 are coupled together (coupling not shown in FIG. 9) to allow communications therebetween. The input/output portion 82 is capable of providing and/or receiving components utilized to implement a dynamic contextual gamer options menu as described above. For example, the input/output portion 82 is capable of providing and receiving information related to game player relationships, information related to relationships between a game player and a game, game options, a dynamic contextual gamer options menu, or a combination thereof, as described above.

The processing portion 78 is capable of implementing a dynamic contextual gamer options menu as described above. For example, the processing portion 78 is capable of, as described above, determining a contextual relationship between game players, determining a contextual relationship between a game player and a game, determining game options in accordance with a relationship between players, determining game options in accordance with a relationship between a game player and a game, updating game options as relationships change, generating a dynamic contextual gamer options menu, or a combination thereof.

The processor 76 can be implemented as a client processor and/or a server processor. In a basic configuration, the processor 76 can include at least one processing portion 78 and memory portion 80. The memory portion 80 can store any information utilized in conjunction with a dynamic contextual gamer options menu. For example the memory portion 80 can store, as describe above, information related to a contextual relationship between game players, information related to a contextual relationship between a game player and a game, game options, a dynamic contextual gamer options menu, or a combination thereof. Depending upon the exact configuration and type of processor, the memory portion 80 can be volatile (such as RAM) 84, non-volatile (such as ROM, flash memory, etc.) 86, or a combination thereof. The processor 76 can have additional features/functionality. For example, the processor 76 can include additional storage (removable storage 88 and/or non-removable storage 90) including, but not limited to, magnetic or optical disks, tape, flash, smart cards or a combination thereof. Computer storage media, such as memory portion 80, 84, 86, 88, and 90, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 76. Any such computer storage media can be part of the processor 76.

The processor 76 can also contain communications connection(s) 96 that allow the processor 76 to communicate with other devices, for example. Communications connection(s) 96 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor 76 also can have input device(s) 94 such as keyboard, mouse, pen, voice input device, touch input device, etc. Output device(s) 92 such as a display, speakers, printer, etc. also can be included.

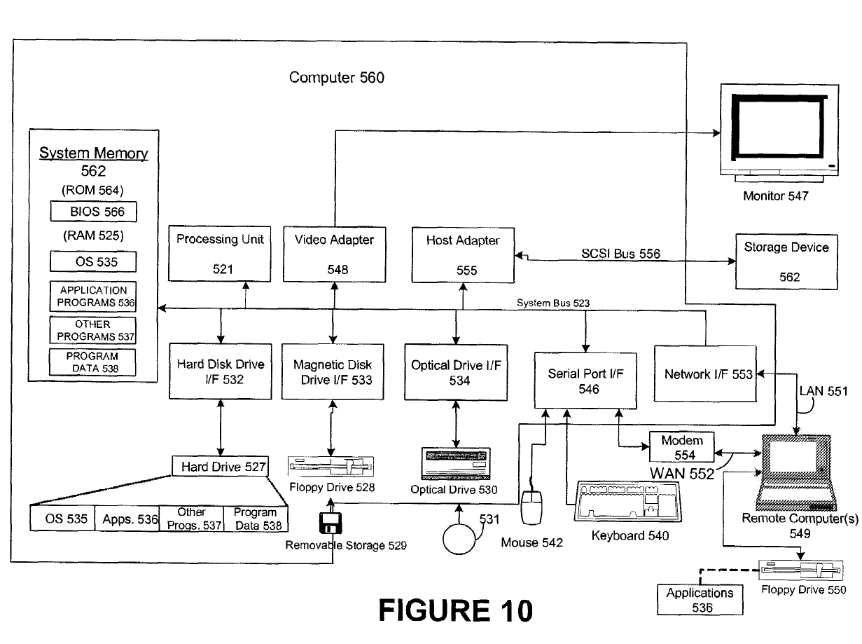

FIG. 10 and the following discussion provide a brief general description of an example suitable computing environment in which a dynamic contextual gamer options menu can be implemented. Although not required, various aspects of a dynamic contextual gamer options menu can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, implementation of a dynamic contextual gamer options menu can be practiced with other computer system configurations, including hand held devices, multi processor systems, microprocessor based or programmable consumer electronics, network PCs, minicomputers, mainframe computers, and the like. Further, a dynamic contextual gamer options menu also can be implemented in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 521, the memory (both ROM 564 and RAM 525), the basic input/output system (BIOS) 566, and various input/output (I/O) devices such as a keyboard 540, a mouse 542, a monitor 547, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with implementing a dynamic contextual gamer options menu as described above.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 10, an exemplary general purpose computing system includes a conventional computing device 560 or the like, including a processing unit 521, a system memory 562, and a system bus 523 that couples various system components including the system memory to the processing unit 521. The system bus 523 may be any of several types of bus structures including a memory bus or memory controller, a peripheral bus, and a local bus using any of a variety of bus architectures. The system memory includes read only memory (ROM) 564 and random access memory (RAM) 525. A basic input/output system 566 (BIOS), containing basic routines that help to transfer information between elements within the computing device 560, such as during start up, is stored in ROM 564. The computing device 560 may further include a hard disk drive 527 for reading from and writing to a hard disk (hard disk not shown), a magnetic disk drive 528 (e.g., floppy drive) for reading from or writing to a removable magnetic disk 529 (e.g., floppy disk, removal storage), and an optical disk drive 530 for reading from or writing to a removable optical disk 531 such as a CD ROM or other optical media. The hard disk drive 527, magnetic disk drive 528, and optical disk drive 530 are connected to the system bus 523 by a hard disk drive interface 532, a magnetic disk drive interface 533, and an optical drive interface 534, respectively. The drives and their associated computer readable media provide non volatile storage of computer readable instructions, data structures, program modules and other data for the computing device 560. Although the exemplary environment described herein employs a hard disk, a removable magnetic disk 529, and a removable optical disk 531, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 529, optical disk 531, ROM 564, or RAM 525, including an operating system 535, one or more application programs 536, other program modules 537, and program data 538. A user may enter commands and information into the computing device 560 through input devices such as a keyboard 540 and pointing device 542 (e.g., mouse). Other input devices (not shown) may include a microphone, joystick, game pad, satellite disk, scanner, or the like. These and other input devices are often connected to the processing unit 521 through a serial port interface 546 that is coupled to the system bus, but may be connected by other interfaces, such as a parallel port, game port, or universal serial bus (USB). A monitor 547 or other type of display device is also connected to the system bus 523 via an interface, such as a video adapter 548. In addition to the monitor 547, computing devices typically include other peripheral output devices (not shown), such as speakers and printers. The exemplary environment of FIG. 10 also includes a host adapter 555, Small Computer System Interface (SCSI) bus 556, and an external storage device 562 connected to the SCSI bus 556.

The computing device 560 may operate in a networked environment using logical connections to one or more remote computers, such as a remote computer 549. The remote computer 549 may be another computing device (e.g., personal computer), a server, a router, a network PC, a peer device, or other common network node, and typically includes many or all of the elements described above relative to the computing device 560, although only a memory storage device 550 (floppy drive) has been illustrated in FIG. 10. The logical connections depicted in FIG. 10 include a local area network (LAN) 551 and a wide area network (WAN) 552. Such networking environments are commonplace in offices, enterprise wide computer networks, intranets and the Internet.

When used in a LAN networking environment, the computing device 560 is connected to the LAN 551 through a network interface or adapter 553. When used in a WAN networking environment, the computing device 560 can include a modem 554 or other means for establishing communications over the wide area network 552, such as the Internet. The modem 554, which may be internal or external, is connected to the system bus 523 via the serial port interface 546. In a networked environment, program modules depicted relative to the computing device 560, or portions thereof, may be stored in the remote memory storage device. It will be appreciated that the network connections shown are exemplary and other means of establishing a communications link between the computers may be used.

While it is envisioned that numerous embodiments of a dynamic contextual gamer options menu are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for implementing a dynamic contextual gamer options menu, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for implementing a dynamic contextual gamer options menu.

The program(s) can be implemented in assembly or machine language, if desired. In any case, the language can be a compiled or interpreted language, and combined with hardware implementations. The methods and apparatuses for implementing a dynamic contextual gamer options menu also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like. When implemented on a general-purpose processor, the program code combines with the processor to provide a unique apparatus that operates to invoke the functionality of a dynamic contextual gamer options menu. Additionally, any storage techniques used in connection with a dynamic contextual gamer options menu can invariably be a combination of hardware and software.

While a dynamic contextual gamer options menu has been described in connection with the example embodiments of the various figures, it is to be understood that other similar embodiments can be used or modifications and additions can be made to the described embodiments for performing the same functions of a dynamic contextual gamer options menu without deviating therefrom. Therefore, a dynamic contextual gamer options menu as described herein should not be limited to any single embodiment, but rather should be construed in breadth and scope in accordance with the appended claims.

What is claimed:

1. A method for specifying game options, the method comprising dynamically specifying a menu comprising at least one game option in accordance with a relationship between a first game player and at least a second game player, wherein:
the at least one game option is dynamically changeable as the relationship changes; and
the at least one game option is specified by a game application.

2. A method in accordance with claim 1, further comprising providing a displayable indication representing each respective one of the at least one game option, wherein:
a number of displayable indications is in accordance with the relationship; and
the number of displayable indications is dynamically changeable as the relationship changes.

3. A method in accordance with claim 1, further comprising:
receiving, by the game application a notification of an occurrence of a user interface event;
obtaining, by the game application, relationship information related to the user interface event;
determining, by the game application, if a game option pertaining to the relationship information is to be specified; and
if a game option pertaining to the relationship information is to be specified, specifying the game option pertaining to the relationship information.

4. A method in accordance with claim 1, further comprising:
selecting a game option from the at least one game option;
receiving, by the game application, an indication of the selected game option;
determining, by the game application, an action related to the selected game option; and
performing, by the game application, the determined action.

5. A method in accordance with claim 1, further comprising:
rendering to the first player a profile of the second player; and
rendering at least one of the at least one game option in accordance with the profile,
wherein the at least one or the at least one game option is dynamically changeable as the profile changes.

6. A method in accordance with claim 1, wherein:
the at least one game option is further in accordance with a game being played; and
the at least one game option is dynamically changeable as the game changes.

7. A method in accordance with claim 1, wherein:
if the second player is not a member of a group, one of the at least one game options comprises a game option to invite the second player to join the group; and
if the second player is a member of a group, a game option comprising an invitation to join the group is not rendered.

8. A system for specifying game options, the system comprising:
a processing portion configured to:
determine a relationship between a first game player and at least a second game player; and
determine at least one game option in accordance with the relationship; and
a display portion configured to dynamically render a menu comprising the at least one game option, wherein the at least one game option is dynamically changeable as the relationship changes.

9. A system in accordance with claim 8, further configured to render, via the display portion, a displayable indication representing each respective one of the at least one game option, wherein:
a number of displayable indications rendered is in accordance with the relationship; and
the number of displayable indication is dynamically changeable as the relationship changes.

10. A system in accordance with claim 8, the processing portion further configured to execute a game application, wherein the game application is configured to:
receive a notification of an occurrence of a user interface event;
obtain relationship information related to the user interface event;
determine if a game option pertaining to the relationship information is to be specified; and
if a game option pertaining to the relationship information is to be specified, render, via the display portion, the game option pertaining to the relationship information.

11. A system in accordance with claim 8, the processing portion further configured to:
select a game option from the at least one game option;
provide, to the game application, an indication of the selected game option;
determine, via the game application, an action related to the selected game option; and
perform, by the game application, the determined action.

12. A system in accordance with claim 8, further configured to:
render, via the display portion, to the first player a profile of the second player; and
render, via the display portion, at least one of the at least one game option in accordance with the profile, wherein the at least one or the at least one game option is dynamically changeable as the profile changes.

13. A system in accordance with claim 8, wherein:
the at least one game option is further in accordance with a game being played; and
the at least one game option is dynamically changeable as the game changes.

14. A system in accordance with claim 8, wherein:
if the second player is not a member of a group, one of the at least one options comprises an option to invite the second player to join the group; and
if the second player is a member of a group, an option comprising an invitation to join the group is not rendered.

15. A computer-readable medium having stored thereon computer-executable instruction for dynamically specifying a menu comprising at least one game option in accordance with a relationship between a first game player and at least a second game player, wherein the at least one game option is dynamically changeable as the relationship changes.

16. A computer-readable medium in accordance with claim 15, the computer-executable instructions further for specifying a displayable indication representing each respective one of the at least one game option, wherein:
a number of displayable indications rendered is in accordance with the relationship; and
the number of displayable indication is dynamically changeable as the relationship changes.

17. A computer-readable medium in accordance with claim 15, the computer-executable instructions further for:
providing to the first player a profile of the second player; and
providing at least one of the at least one game option in accordance with the profile,
wherein the at least one or the at least one game option is dynamically changeable as the profile changes.

18. A computer-readable medium in accordance with claim 15, wherein:
the at least one game option is further in accordance with a game being played; and
the at least one option is dynamically changeable as the game changes.

19. A computer-readable medium in accordance with claim 15, wherein:
if the second player is not a member of a group, one of the at least one game options comprises a game option to invite the second player to join the group; and
if the second player is a member of a group, a game option comprising an invitation to join the group is not rendered.

20. A computer-readable medium in accordance with claim 15, the computer-executable instructions further for:
receiving, by the game application a notification of an occurrence of a user interface event;
obtaining, by the game application, relationship information related to the user interface event;
determining, by the game application, if a game option pertaining to the relationship information is to be specified; and
if a game option pertaining to the relationship information is to be specified, specifying the game option pertaining to the relationship information.
